(19) United States
(12) Patent Application Publication
(10) Pub. No.: US 2008/0201299 A1
(43) Pub. Date: Aug. 21, 2008

(54) Method and System for Managing Metadata

(75) Inventors: Juha Lehikoinen, Lakiala (FI); Ilkka Salminen, Tampere (FI); Pertti Huuskonen, Tampere (FI); Timo Sorsa, Espoo (FI); Harri Lakkala, Tampere (FI); Tero Hakala, Kangasala (FI); Mika Karhu, Pirkkala (FI)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 11/630,238

(22) PCT Filed: Nov. 29, 2004
(86) PCT No.: PCT/US2004/039784

§ 371 Date: Dec. 19, 2007

Related U.S. Application Data
(63) Continuation-in-part of application No. 10/880,428, filed on Jun. 30, 2004, now abandoned.

(51) Int. Cl. G06F 7/06; G06F 17/30; G06F 21/00; G06F 3/048

(52) U.S. Cl. 707/3; 726/2; 715/771; 707/103 R; 707/E17.014

(57) ABSTRACT

Methods and systems for managing metadata are described. The method comprises steps of receiving a request from an application to access a metadata attribute corresponding to a piece of content, determining whether the application is authorized to access the metadata attribute, retrieving the metadata attribute upon determining that the application is authorized to access the metadata attribute, and transmitting the metadata attribute to the application. A metadata storage medium may be accessed and searched for the metadata attribute. A system for associating content data, context data, and an event is also described. The system allows for a user to search for content data based upon context data. Another method for associating data is described. The method includes steps of initiating a mufti-media call session, initiating an application independent of the mufti-media call session, and associating collected metadata from the application and the mufti-media call session.

This application is a continuation-in-part of and claims priority from pending U.S. application Ser. No. 10/880,428, entitled, “Method and System for Managing Metadata,” filed Jun. 30, 2004.

### FIELD OF THE INVENTION

The invention relates to user content management. More particularly, the invention relates to systems and methods for processing requests for information associated with user content.

### BACKGROUND OF THE INVENTION

Uses for mobile devices continue to evolve. Today, a mobile phone has capabilities to capture still pictures, capture video sequences, send messages, send image files, send text messages, maintain contact information, and connect to the Internet. To handle all of the features, mobile devices require more memory. Available memory in mobile devices will shortly reach gigabyte levels. Mobile electronic devices already have cameras to take still and video images. With the ease of data capture and transfer, there will be hundreds if not thousands of video clips and still images in any given mobile device. The amount of stored content increases even more when the images and video clips can be sent to other users. Editing images and creating new films and multimedia presentations has become a norm. However, the input capabilities of a mobile device will always be somewhat limited (e.g., a dozen or so buttons).

There are numerous problems when utilizing metadata. One problem relates to the semantics of a metadata attribute. The creator of a painting is the actual painter. However, the creator of a song is vague. The creator of a song may be the artist, the composer, the producer, or the arranger. When the object that the metadata describes is a part of another object, e.g., a song that belongs to the soundtrack of a movie, the semantics of the metadata attribute is even more difficult. Determining the most appropriate semantic of each metadata attribute to allow application writers to use the metadata and to allow the metadata being converted from a format to another has become more important.

Another problem in dealing with metadata is input of descriptive information. Today, it is not realistic to assume that a user will manually annotate her content to a large extent. A user taking various pictures with a digital camera will often fail to input any information to describe the content, other than a title for each picture when saving the digital photos. As a result, there is a need for automatic creation of as much metadata about a piece of content as possible.

Still another problem with utilizing metadata is the ability to search for personal content. For example, a user sends a text document to a friend, describing potential directions for their vacation planned for next summer. A few months later, the user cannot find the document anywhere. She may not remember the name of the file or the location in the folder structure. The user cannot track documents sent during a particular time or to a particular person.

Currently, some metadata is collected by computing systems, such as mobile phones and personal computers (PCs). As an example, a mobile phone keeps track of sent messages, including whom the message was sent to, what the type of the message was, and what the date of sending was. A problem with this collection is that all media items that are included in the process cannot be referenced to at a later time. For example, the user is not able to open an image to see the people to whom the image has been sent even though the underlying information exists.

There is no standard way to maintain metadata. How metadata is managed depends on the media type, format of the object, or just how an application developer preferred to implement it into the application. In addition, metadata is usually stored inside the objects themselves, i.e., the metadata is embedded into the object. With the additional embedded information, the size of the object increases and the ability to edit or read the metadata is more difficult. Further, because one is embedding the metadata into the object, there is a compromise in privacy. Metadata may be sensitive or private and it is exposed to misuse when it is embedded inside the content object.

In the simplest form, metadata management systems merely display the metadata related to a media object in a plain text-based list. Some advanced systems include a screen to visualize metadata or to interact with single metadata items. However, there is no system that creates metadata-based relations between two content objects and brings that relation information to the user.

In addition to content data and data corresponding to an event, such as the capture of an image by a camera, context data can be useful in identifying and/or classifying content data. Context data includes the current state of an entity, such as a user of a mobile device, the surrounding environment, or the mobile device itself. Context data also includes weather conditions, applications that are currently running on the mobile device, and the location where the event occurred.

Conventional context-acquiring systems fail to store the context data as metadata, relevant to the content data, which can be used at a later time for accessing the content data. Conventional context-acquiring systems fail to associate context data with interaction events. Conventional systems either provide live context information to applications that can process the context information, or alternatively store only one piece of context data, usually context data at the time of creation. As such, conventional systems fail to provide a systematical way of frequently storing and accessing context information.

Currently, managing data associations within a Rich Call session is also limited to metadata acquired within the Rich Call session. A Rich Call session includes a call combining different media and services, such as voice, video, and mobile multimedia messaging, into a single call session. One type of Rich Call session network is an all-IP network that uses Internet Protocol (IP) technology throughout the network. The all-IP radio-access network (RAN), an IP-based distributed radio access architecture, is another Rich Call session network. All-IP technology combines different radio technologies into one radio-access network with optimized end-to-end Quality of Service.

The all-IP network consists of an all-IP RAN, which integrates different radio access technologies into a single multi-radio network, and an all-IP core, which enables multimedia communication services over different access networks. The all-IP network may use standard Third Generation Partnership Project (3GPP) air- and core-network interfaces to secure full interoperability with existing networks. The all-IP core enables rich calls and thus generates additional traffic and revenue for operators. The all-IP RAN multi-radio architecture combines different radio technologies into a unified access network through the use of common radio resource management, common network elements, and advanced control functions.

Currently it is not possible to tie the actions/results, such as files created by other programs, which were used during a multi-media call session. It is possible to use other applications, such as an application to take notes, but it is not possible to determine automatically which note belongs to which multi-media call session. The user has to save the file with a name that describes the context the best. Only that way is she able to find the right note that was written during the particular multi-media call session.

The user could use other applications during the call, such as the notes application, to write some notes. The user then can save the file into a file system and open it at a later time. However, the user must initiate the action, know where she saved the file, and know which file was related to which multi-media call session. Conventional systems fail to automatically allow a user to associate data, which is not part of a multi-media call session, with multi-media call session data.

### BRIEF SUMMARY OF THE INVENTION

It would be an advancement in the art to provide a method and system for managing metadata.

According to aspects of the present invention, a request from an application to access a metadata attribute corresponding to a piece of content is received and a determination is made as to whether the application is authorized to access the metadata attribute. The requested metadata attribute is retrieved upon determining that the application is authorized to access the metadata attribute, and the requested metadata attribute is then transmitted to the application.

Another aspect of the present invention includes a metadata storage medium that may be accessed and searched for the metadata attribute. Still another aspect allows the metadata storage medium to be encrypted to provide additional security.

Another aspect of the present invention includes a terminal device for managing metadata including separating content object form corresponding metadata attributes. Still another aspect of the present invention provides a user interface configures to indicate when new relation information about a content object is received by a terminal device.

Another aspect of the present invention provides a method for detecting an event, collecting content and context data, and associating the content data and the context data with the event, such as the capture of an image by a camera. The content data can be accessed by searching based upon the context data and/or the event.

Still another aspect of the invention is related to managing data associated with multi-media call sessions. In a multi-media call session, logging of data is enhanced to contain other information not directly part of the multi-media call session.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a block diagram of an illustrative model for utilizing personal content in accordance with at least one aspect of the present invention;

FIG. 2 is a functional block diagram of an illustrative electronic device that may be used in accordance with at least one aspect of the present invention;

FIG. 3 illustrates a block diagram of an illustrative system for processing metadata in accordance with at least one aspect of the present invention;

FIG. 4 illustrates a block diagram of an illustrative system for processing metadata in accordance with at least one aspect of the present invention;

FIG. 5 illustrates a system for processing requests for metadata information in accordance with at least one aspect of the present invention;

FIG. 6 illustrates a block diagram of illustrative entries in a storage medium in accordance with at least one aspect of the present invention;

FIG. 7 illustrates a flowchart for processing a request to process metadata in accordance with at least one aspect of the present invention;

FIGS. 8A and 8B illustrate schematic displays on a terminal device in accordance with at least one aspect of the present invention;

FIG. 9 illustrates a sequence diagram for communications within a system for managing data in accordance with at least one aspect of the present invention;

FIG. 10 illustrates a flowchart for associating and accessing data in accordance with at least one aspect of the present invention;

FIG. 11 illustrates a block diagram of an example system for managing data in accordance with at least one aspect of the present invention;

FIG. 12 illustrates another flowchart for associating and accessing data in accordance with at least one aspect of the present invention; and

FIG. 13 illustrates another block diagram of an example system for managing data in accordance with at least one aspect of the present invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

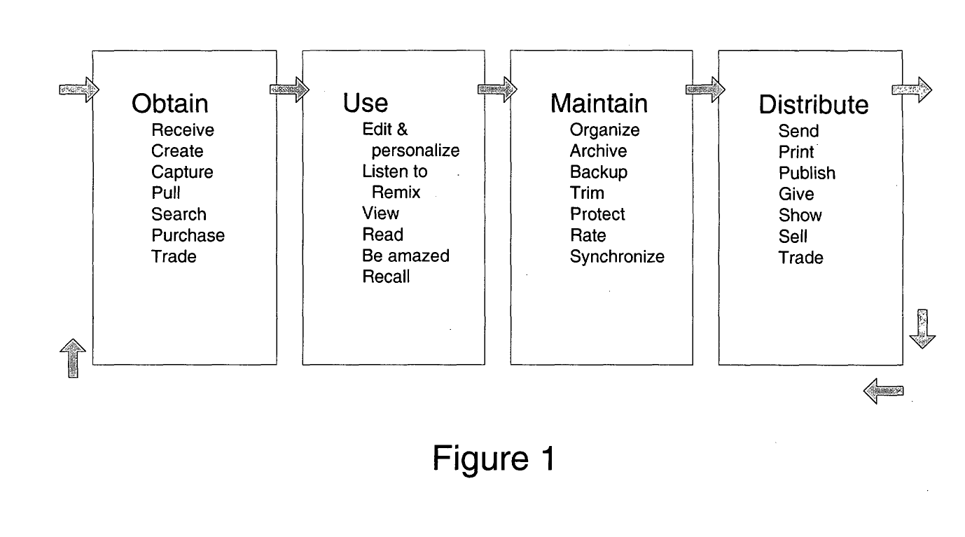

FIG. 1 is an illustrative model for utilizing personal content. FIG. 1 illustrates the lifecycle of personal content usage. First, the user obtains the content from somewhere. Some examples are shown in FIG. 1, including the user receiving a file, accessing a file, creating a file, contacting a person, capturing a still image, and purchasing a file. Next, the user can use the content while at the same time maintaining it (more or less). For example, as shown the user can edit and personalize the content, view the content, and/or listen to the content. For maintaining the content, the user can organize the content, archive the content, and backup the content for storage. Finally, some pieces of content may be distributed by sending, publishing, and selling the content. Thereafter, the shared piece of content will continue its lifecycle in some other device.

Personal content may be described as any digital content targeted at human sensing that is meaningful to the user, and is controlled or owned by the user. This includes self-created content in addition to content received from others, downloaded, or ripped. One aspect for maintaining efficient content management is metadata. The term “metadata” is not unambiguous. What may be data for some application may be metadata for some other. For example, the call log in a mobile phone is data for a log application, while it is metadata for a phonebook application. As used herein, the term metadata describes all information that provides information of a content object. It is structured information about some object, usually a media object. It describes the properties of the object. For example, with respect to a document created on a word processing application, the document itself is the content object, while the authors of the document are a part of the metadata of the content object (other parts include the number of words, the template used to create the document, the date of the last save, etc.). Metadata is used to organize and manage media objects. For instance, if there are hundreds of documents and pictures, metadata may be used to find, sort, and handle the large number of files.

In addition to metadata that directly describes content, there is also metadata that is indirectly related to the object. For example, the person that a user sends an image to is a part of the metadata of the image. In such a case, the metadata is also a content object itself; therefore, metadata creates a relation between these two objects.

Each individual piece of metadata is referred to as a metadata attribute. As an example, a digital photo might be the content object, all information describing the image is its metadata, and the color depth is a metadata attribute. There are many examples of metadata. Some types are direct single data items, such as the bit rate of a video stream. Metadata is not limited to such cases. A thumbnail image of a digital photo is also metadata, as is the fact that the song “ABC.MP3” is part of a collection entitled “My Favorite Songs”.

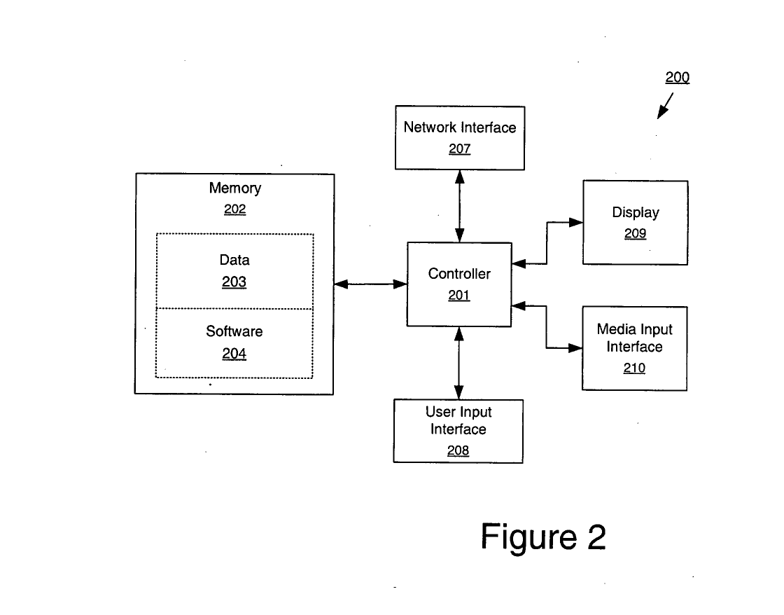

FIG. 2 is a functional block diagram of an illustrative computer 200. The computer 200 may be, or be part of, any type of electronic device, such as a personal computer, personal digital assistant (PDA), cellular telephone, digital camera, digital camcorder, digital audio player, GPS device, personal training/fitness monitoring device, television, set-top box, personal video recorder, watch, and/or any combination or subcombination of these, such as a camera/phone/personal digital assistant (PDA). The electronic device may be a mobile device, which is a device that can wirelessly communicate with base stations and/or other mobile devices. The computer 200 of the electronic device may include a controller 201 that controls the operation of the computer 200. The controller 201 may be any type of controller such as a microprocessor or central processing unit (CPU). The controller 201 may be responsible for manipulating and processing data, for executing software programs, and/or for controlling input and output operations from and to the electronic device. The controller 201 may be coupled with memory 202, one or more network interfaces 207, a user input interface 208, a display 209, and/or a media input interface 210.

The network interface 207 may allow for data and/or other information to be received into, and/or to be sent out of, the electronic device. For example, data files may be sent from one electronic device to another. Where the electronic device is a mobile device, the network interface 207 may be a wireless interface, such as a radio frequency and/or infra-red interface. Where the electronic device is a non-mobile device, the network interface 207, if one exists, may be a wired interface such as an Ethernet or universal serial bus (USB) interface. In a mobile device, the network interface 207 might include only a wireless interface or both a wireless interface and a wired interface.

The user input interface 208 may be any type of input interface, such as one or more buttons (e.g., in the form of a keyboard or telephone keypad), one or more switches, a touch-sensitive pad (which may be transparently integrated into the display 209), one or more rotatable dials, and/or a microphone for voice recognition.

The display 209 may be any type of display, including but not limited to a liquid crystal display (LCD), a light-emitting diode (LED) display, an organic-LED (OLED) display, a plasma display, and/or an LCD projector. The display 209 may be physically divided into one or more displayable portions, and may include one or more display screens and/or one or more individual indicators such as status lights.

The media or other input interface 210 may provide media data (i.e., audio, video, text, monitoring data, and/or still images) to the computer 200. The media or other input interface 210 may include or be coupled to media input devices, e.g., a microphone, a still image camera, a video camera, and/or one or more sensor devices, such as a thermometer, altimeter, barometer, pedometer, blood pressure apparatus, electrocardiograph, and blood sugar apparatus. The processor 201 may store such media data in one or more media files in the memory 202. The processor 201 may further cause media data to be displayed on the display 209, be output to a speaker, and/or to be sent out of the electronic device (e.g., to other electronic devices) via the network interface 207. Media data, which may be in the form of media files, may also be received (e.g., from other electronic devices) by the computer 200 via the network interface 207.

The memory 202 may be any type of memory such as a random access memory (RAM) and/or a read-only memory (ROM). The memory 202 may be permanent to the electronic device (such as a memory chip on a circuit board) or may be user-changeable (such as a removable memory card or memory stick). Other types of storage may be alternatively or additionally used, such as a hard disk drive, flash memory, etc. The memory 202 may store a variety of information useful to the electronic device, such as software 204 and/or data 203. The software 204 may include one or more operating systems and/or applications. The data 203 may include data about the electronic device, user files, and/or system files. For example, media files may be stored in the data 203 portion of the memory 202. Although the memory 202 is shown as being divided into separate portions in FIG. 2, this is merely shown as a functional division for explanatory purposes. The memory 202 may or may not be divided into separate portions as desired. Data, such as media files, may further be stored external to the electronic device such as on a different electronic device and/or on a network. In this case, the memory 202 may be considered to include such external storage.

In accordance with another aspect of the present invention, a central service in a terminal device and/or a server is provided for managing metadata; therefore the metadata can be used in a standard way in all applications. Methods and systems are provided for protecting the metadata from unauthorized usage. Methods and systems are provided for extracting and creating the metadata. Methods and systems are provided for collecting and storing the metadata. The metadata management and storage system separates the metadata from the objects it describes. The metadata management and storage system provides a unified service to all applications utilizing metadata. It also provides a single control point to all metadata and increases the data protection. The system may be a piece of software that resides inside the terminal device and/or server. It provides the applications in the terminal device and/or server with unified access to the metadata, ensuring that only authored software is permitted.

The metadata management system includes three parts. First, an API for applications is used to query and store metadata. Applications can also subscribe to be notified about changes in metadata. Second, a control point or gatekeeper component checks if an application has rights to know about or access the metadata they are querying. Third, a storage system stores all kind of metadata with links to the object that the metadata describes. The links may be local or external, i.e., the object that the metadata describes does not need to be stored in the same terminal device and/or server. Metadata may be stored in an encrypted form in the database, making it useless for unauthored applications if accessed. The same metadata item can describe several objects. Objects may not be physically stored in the same place as metadata items.

The client API may have three functions. A GetMetadata( ) function gets a metadata item from the management system. This function has a condition or filter (e.g., file name) as a parameter and the system returns all metadata matching the criteria. A SetMetadata( ) function stores the metadata item into storage. This function has the metadata item and the object identifier as parameters. The system stores the metadata item and attaches it to the object. A SubscribeToChange( ) function asks the system to notify the application when a given metadata changes, or when metadata of a given file changes. This function may have the same parameters as the GetMetadata( ) function. When the metadata matching the criteria changes, the application is notified and given the changed metadata.

The gatekeeper component may be a Symbian-type server. All client API calls go through the gatekeeper component. The gatekeeper component checks that the calling application has sufficient rights before using the storage system to retrieve or store the metadata. If a metadata item is changed by the SetMetadata( ) call, the gatekeeper component notifies all applications that have subscribed to changes. The storage system may be a Symbian-type server with its own database or another data management system. The database may be encrypted only allowing the gatekeeper component to call the storage system and decrypt the metadata. The storage system may store all events and metadata items.

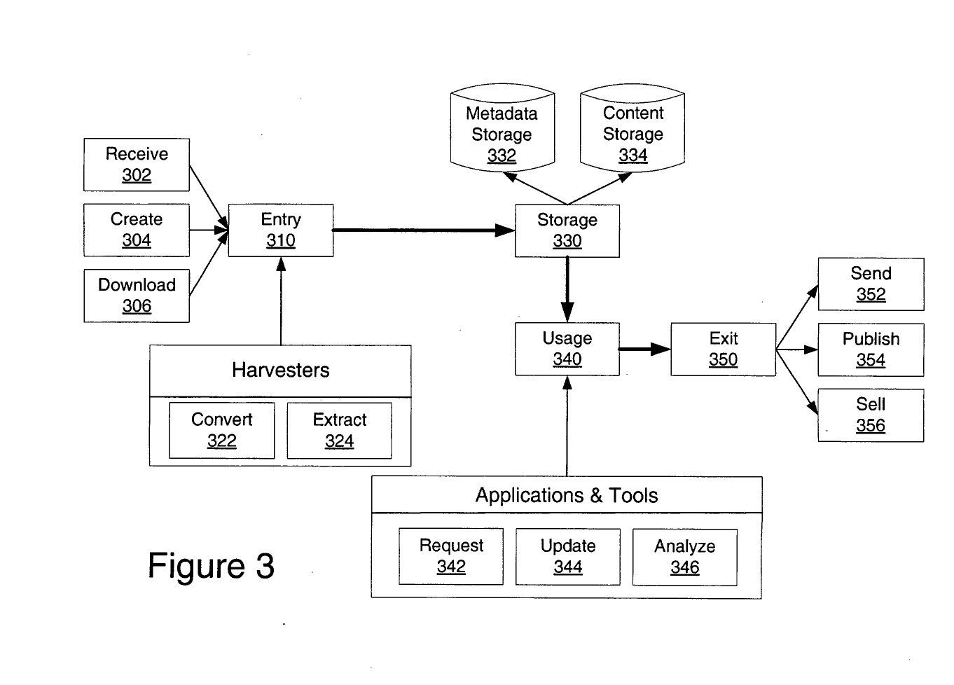

In accordance with at least one aspect of the present invention, a model for the metadata management and storage system consists of an entry point, a storage point, a usage point, and an exit point. Such an illustrative model is shown in FIG. 3. Upon arriving 310 into a user's device, such as a mobile telephone, a piece of content is examined for metadata. For example, the piece of content may originate because the user received 302 the content, because she created 304 the content, or because she downloaded 306 the content. The examination may be conducted by a conversion system 322 and/or an extraction system 324. The examination of the piece of content may be based on extraction for known metadata formats or it may be a brute-force extraction method from the whole object. Further, the examination may include feature recognition, such as identifying faces in an image. Once the metadata is extracted, it is stored 330. The metadata is stored separately from the objects itself; any preexisting metadata already embedded within the object may not be separated from the object. The metadata is stored in a metadata storage system 332 and the content of the object is stored in a content storage system 334. In accordance with at least one aspect of the present invention the metadata storage system 332 may be in a different device than the content storage system 334. For example, metadata storage system 332 may reside in a network server and the content storage systems 334 may reside in a plurality of different devices.

When an application has requested metadata for some type of use 340, the access rights of the application with respect to the metadata are examined. Only applications that are authorized to access the desired piece of metadata are allowed access to it. Whenever the user interacts with the content object, the interactions are stored as metadata. Further, different engines can further process the metadata, e.g., to create associations that may be stored as metadata. Illustrative applications seeking to use metadata include requesting 342 metadata, updating 344 metadata, and analyzing 346 metadata. Finally, once the user shares 350 a piece of content, the metadata privacy attributes are checked. Information of the shared pieces or content, such as to/with whom the content is shared and when the content is shared, may also be stored as metadata. Some metadata attributes that are marked as shareable may be embedded in the object upon exit 350, while other metadata may be kept private. Examples of how a user may share include sending 352 the piece of content, publishing 354 the piece of content, and selling 356 the piece of content.

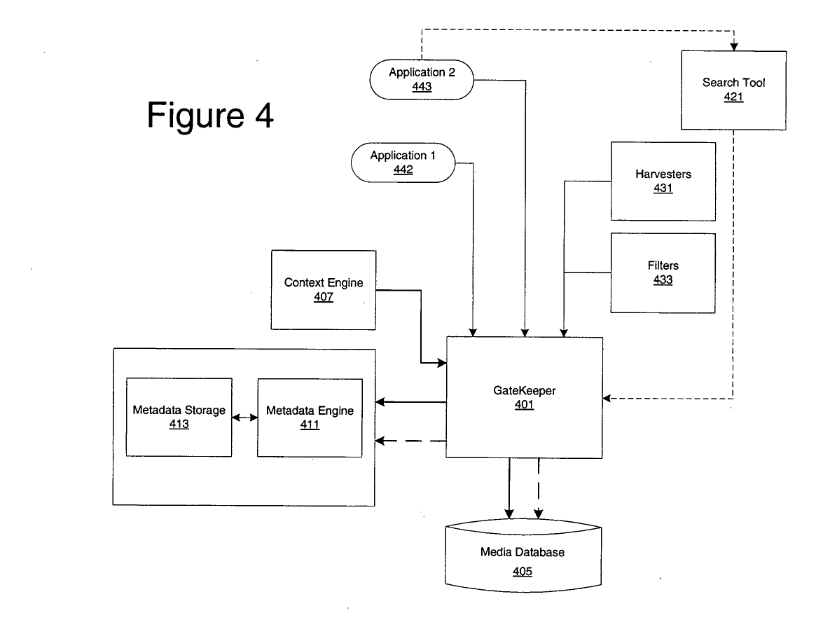

In accordance with one aspect of the present invention, the architecture of the metadata management and storage system includes a gatekeeper 401, a metadata engine 411, a search tool 421, a metadata database 413, harvesters 431, filters 433, and a context engine 407 as illustrated in FIG. 4. The gatekeeper 401 acts as a safeguard between the stored metadata in the metadata storage 413 and applications 442 and 443. The gatekeeper 401 provides applications 442 and 443 with access to the metadata according to their access rights. The gatekeeper 401 may also allow or deny storing of metadata and/or a piece of content. Metadata engine 411 takes care of all actions with the stored metadata. It provides interfaces for storing, requesting, and subscribing to changes in metadata. Search tool 421 is a cross-application tool that provides search functionality. Metadata database 413 is a relational database that contains the metadata attributes for each content object. Harvesters 431 are a set of system-level software components that analyze content with different methods, such as feature recognition and text extraction, and that store the results as a set of metadata. Filters 433 are a type of harvester that extracts known metadata formats from content, such as EXIF from images. Finally, context engine 407 provides applications 442 and 443 and the system with information of the current context.

The harvesters 431 and filters 433 extract the metadata from content objects as the content objects arrive. In accordance with at least one aspect of the present invention, the harvesting may also be timed. For example, the harvesters 431 may be launched when a terminal device is idle and charging. The harvesters 431 may search for existing metadata formats within objects or they may be used to analyze the object and create new metadata entries. Harvesters 431 may extract metadata based on a known metadata format directly from the content object or they may perform brute-force text extraction. Harvesters 431 may reside in a remote area. In these cases, the content is sent for analysis to a remote network server with the harvesters and the filters, which then harvests the metadata and returns the results.

Once extracted, the metadata is stored in a database 413, separately from the content objects in the media database 405. The separation allows for an increase in security so that private metadata will not be accessible and/or changed. Alternatively, the separation allows for many or all users of a system to access the metadata. Along with metadata, the metadata and storage system stores references to the actual objects. The references may be URIs used to identify the location of the content object. The actual object may be stored locally, in a server, or it may be a movie on a DVD disc, or music on a portable storage medium that cannot be accessed at all by the terminal device. Instead of having static fields in a database, each attribute is stored as a property. For example, the attribute name and value may be stored. In a database, both the name and value are character strings and the actual data type of the value is described in the metadata ontology. Once new metadata attributes are introduced, no changes in the table are required; they may be stored in the table as any other metadata. This also allows applications to specify their own proprietary metadata attributes.

Metadata stored in the database can be used in many ways. It may be accessed by applications 442 and 443 that need to process it some way, e.g., to show to the user. The metadata also may be used by tools that process it in order to make associations, relations, or categorizations. Further, metadata may be updated or augmented by many applications, thereby creating new metadata in the form of histories, such as a superlog including interaction history and a contextlog with context snapshots.

It should be understood by those skilled in the art that aspects of the present invention may be utilized entirely within a terminal device, such as a cellular phone and/or a personal digital assistant (PDA) of a user, may be utilized entirely within a server, and/or may be utilized within a system that includes a terminal device and a server where certain aspects are performed within the terminal device and certain aspects are performed within the server. The present invention is not so limited to the illustrative examples described within the Figures.

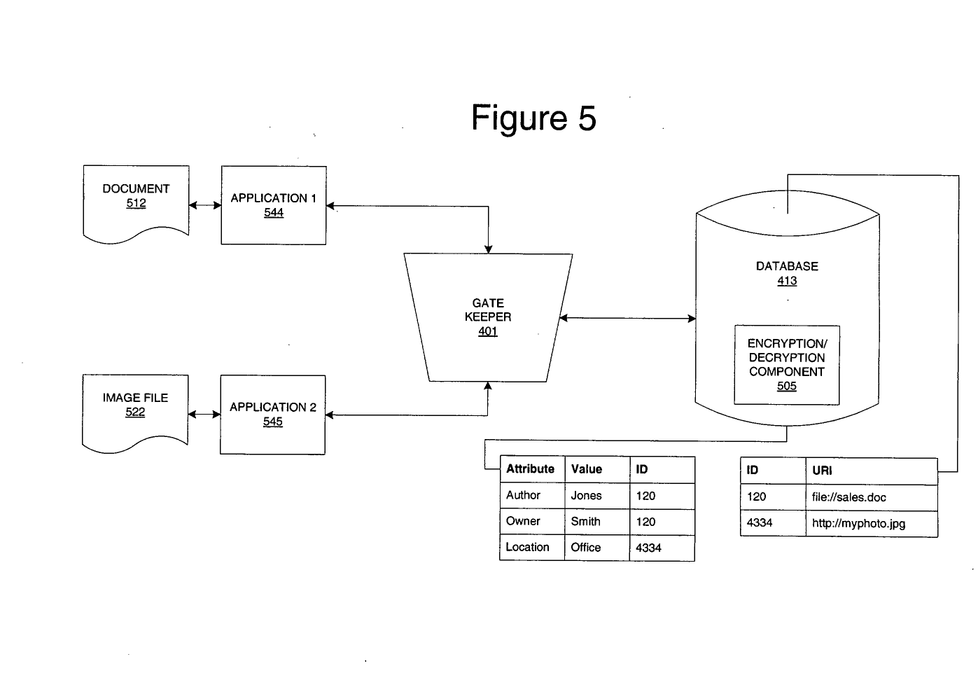

FIG. 5 illustrates an example of two different applications 544 and 545 requesting access to metadata in accordance with at least one aspect of the present invention. Application 1 544 receives a document 512. Application 2 545 receives an image file 522. When the applications or tools request access to metadata, they contact the gatekeeper component 401. The gatekeeper component 401 verifies the access rights of the requesting application 544 and 545 and provides the application with metadata that it is allowed to access. The gatekeeper component 401 uses the metadata engine to retrieve the metadata from the metadata database 413 and to filter unauthorized metadata out. In the first example, Application 1 544 requests the gatekeeper component 401 for the “Author” metadata for document “sales.doc”. The gatekeeper component 401 determines whether the Application 1 544 has access rights. In this case, Application 1 544 is authorized to access the “Author” metadata so the gatekeeper component 401 retrieves from the storage database 413 the items that describe the “sales.doc” and then gets the value of the “Author” property, decrypts it using the encryption/decryption component 505 and sends it back to Application 1 544. In another example, Application 2 545 request the gatekeeper component 401 for the “Location” metadata for remote picture http://mypicjpg. The gatekeeper component 401 determines that Application 2 545 has no rights for the requested metadata attribute, so the gatekeeper component 401 does not fulfill the request of Application 2 545.

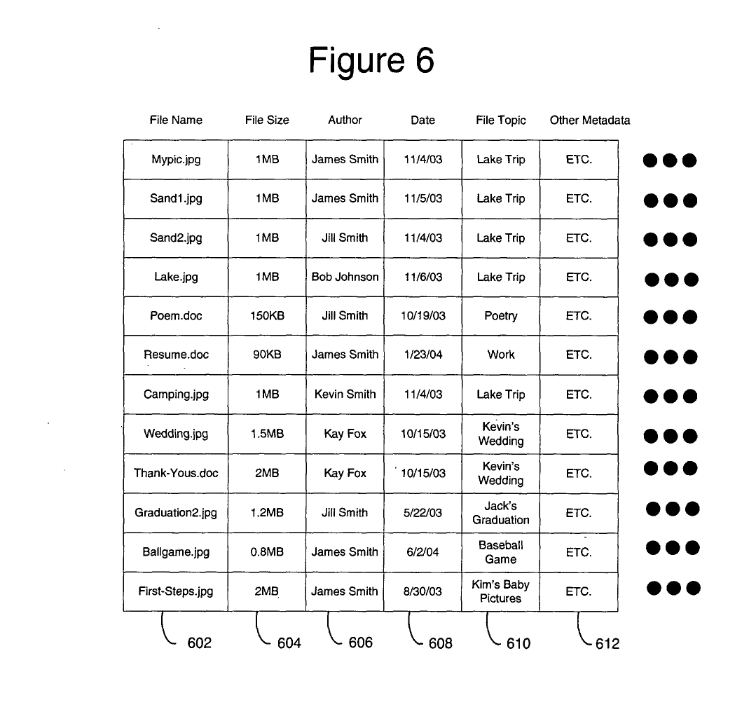

FIG. 6 illustrates a block diagram of illustrative entries in a storage database 413 in accordance with at least one aspect of the present invention. Metadata of various types and information are shown. For example, column 602 is a listing of the file names stored in the storage database 413. Column 604 is a listing of the file size for each respective file. Column 606 is a listing of the author metadata attribute and/or an originating device metadata attribute for each respective entry. Column 608 is a listing of the date the metadata was saved to the storage database 413. Column 610 is a listing of the topic describing the file and column 612 is a listing of other metadata attributes, such as how many times the file has been accessed and/or by whom and when the file has been accessed, how many times a particular metadata attribute has been accessed and/or by whom and when the particular metadata attribute has been accessed, how many times the file has been delivered and/or by whom and to whom and when the file has been delivered, how many times a particular metadata attribute has been delivered and/or by whom and to whom and when the particular metadata attribute has been delivered, and when the last time the metadata information for a file was changed and/or by whom and when the last time the metadata information for the file was changed. It should be understood by those skilled in the art that the present invention is not limited to the entry configuration and/or metadata entries shown in FIG. 6.

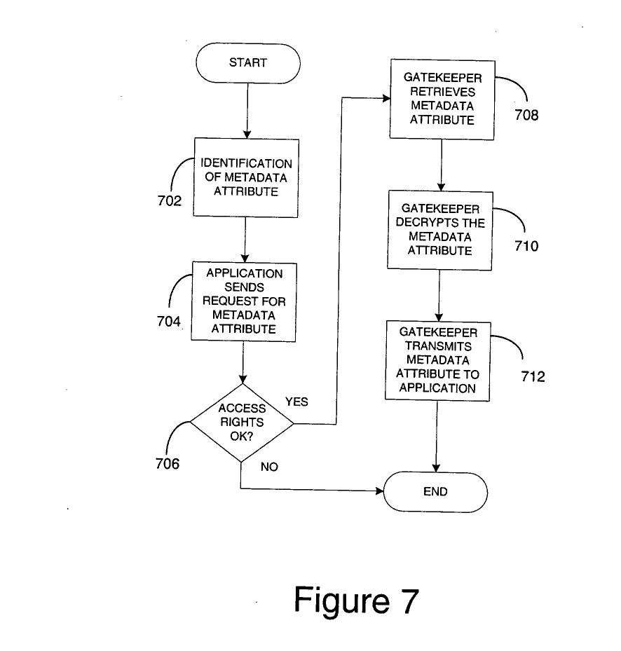

FIG. 7 illustrates a flowchart for processing a request to process metadata in accordance with at least one aspect of the present invention. The process starts and proceeds to step 702 where the metadata attribute of interest to the user is identified by the application. At step 704, the application sends a request for the metadata attribute of interest to the gatekeeper component. The process then proceeds to step 706 where a determination is made as to whether the application requesting the metadata is authorized to access the requested metadata. For example, if the metadata attribute requested is private, the gatekeeper component may determine that the requesting application has no access rights to the metadata attribute requested or the metadata at all. If the determination is that the application has no access rights, the process ends and the gatekeeper may inform the application that the requested metadata attribute is restricted from the application. If the application does have access rights, the process proceeds to step 708.

At step 708, the gatekeeper retrieves the requested metadata attribute. The process continues to step 710 where the gatekeeper component decrypts the metadata attribute before sending the requested metadata attribute to the requesting application. Alternatively, the storage database maintaining the metadata attributes may be configured to decrypt the requested metadata attribute before sending it to the gatekeeper component. At step 712, the gatekeeper component transmits the decrypted metadata attribute to the requesting application. Alternatively, the gatekeeper component may encrypt the metadata attribute before sending the requested metadata attribute to the requesting application.

Once a request for a metadata attribute has been received, the gatekeeper component can search the metadata in the metadata storage database. Searching is one activity that benefits from accurate and descriptive metadata. Accurately tagged content objects can be searched for based on their metadata. Metadata extracted by the means of a feature recognition method also may be used as a means of searching for the actual content, not just its metadata. As a result, the user receives more accurate results with less effort. In addition to basic searching, however, metadata may also contribute indirectly. For example, metadata can automatically provide created profiles and preferences. This information can be used for prioritizing search results and for filtering.

In accordance with one aspect of the present invention, metadata ties different content types together, i.e., the relations between content objects themselves. The ability to link people with files and time provides a more powerful searching capability in terms of versatility and comprehension. Metadata also allows for limited proactive searching, such as for a calendar. The calendar entries, together with the relevant content objects, may be used as a basis for searching for more information on the same topic. This information is readily available for accessing once the actual event takes place.

Metadata provides several benefits to a user in content management. Metadata may be used as a basis for automatic content organization, such as creating automated playlists or photo albums. Examples of criterion include, “Show me all photos that contain one or more persons”, and “I want to listen to 10 music tracks in my collection that I have listened to on an earlier weekend”. This allows for creating automated new collections dynamically.

Metadata can also help in tracing content history or a lifecycle. “When and where did I get this photo?” and “when was the last time I accessed this file?” are typical questions in tracing content. Furthermore, the relations between objects help build an overall view of the history, not just that of a single content object. Metadata can be used to recreate a past event by collecting all relevant objects, and presenting them as a multimedia collage of the event.

A method for automatically collecting metadata that is related to a user's interaction with content is described in accordance with at least one aspect of the present invention. In one embodiment, a metadata-enabled access system provides access to metadata content while preserving memory size in the content object and privacy for metadata that is not open to the public. Aspects of the present invention are based on a system-level component that is used by all applications. This system-level component may be a message-delivery system that can be used by applications to inform others of the status of the application. For example, when an image is opened in an application, the application may inform the overall system that image xyz.jpg has been opened. This application provides information. Then, any other application that is interested in some or all of this information can use the information the best way the other application sees fit. This other application consumes information.

One type of information consumer is a superlog system. Whenever any application, such as an imaging application, a messaging application, or any other application, informs that the user has interacted with a certain content object, the superlog system stores this information for future use. The information stored by the superlog system can then be exploited by any other information provider. For example, a software component may be used that can find associations between people and files. This software component uses the information stored by the superlog system in order to create the associations.

Implementation of a superlog system may consist of three parts: the information consumer that collects the events and stores them, the actual data storage for the events, and the information provider that creates the associations between the stored objects. The data storage may be implemented as a table in a relational database inside a terminal device and/or server. Such a table may contain the following information:

TABLE 1
Superlog Data Storage Table

| | |
|---|---|
| TIMESTAMP: | the time of the event |
| OBJECT_ID: | an identifier to the relevant content object (which is |
| | stored elsewhere in the database or in the file system) |
| ACTION: | an enumerated code for the action |
| | (e.g., 1 = saved, 2 = opened, etc.) |
| ACTOR: | an identifier of the application that created the event |
| PEOPLE: | a list of people associated with this event (may be NULL; |
| | the IDs are pointers to the phonebook data table) |

Applications use the superlog by making database queries. These database queries may be SQL queries to the superlog database, but there is no need to expose the end user to SQL. The applications will create the queries based on a user action. For example, a user uses a phonebook application to display all documents that were sent to a friend. The phonebook application performs a SQL query searching all records where the ACTION parameter has a code for “sent” and the PEOPLE parameter contains the phonebook entry ID for the friend. The result of the query may be then formatted to fit the needs of the application and, if needed, further filtered using timestamp or actor fields.

In accordance with at least one aspect of the present invention, a superlog system for automatically collecting metadata that can help in managing the growing amount of personal content stored in terminals and other devices is provided. The superlog system enables very versatile formation of different relations between objects, applications, people, and time, thus providing several different ways of accessing the content.

A superlog system stores the action of a user with content objects. Whenever an action is performed, e.g., save, send, or receive, a log entry is created for the event. The log entry contains a reference to the content object, a timestamp, an indication of the type of the action, and a reference to a contextlog. The superlog system may also store any related people or contacts. The superlog system may not store all interactions. It allows a user to access a brief interaction history of an object, to find related people, and to query the context at the time of the action. This information can further be used to form more complex associations between objects, people, and contexts.

A contextlog system is used to store a snapshot of the current context. It stores relevant information that is related to the current state of the user, the device, or the environment. This may include information such as battery strength, currently opened applications, or weather information. Together with the superlog system, these two logs allow for greater flexibility in creating associations between personal content.

Because the metadata is stored separate from the objects, security for restricting access is increased. The metadata and objects may be stored in a database. A database offers several benefits over a traditional file system, such as indexing, built-in means of synchronization and back-up, and efficient access control. The database may be local or remote.

In accordance with at least one aspect of the present invention, a system for visualizing, accessing, and interacting with metadata-based relations between media objects is provided. The system consists of a method for storing the relations and a user interface for accessing and controlling them. The relations may be created manually by a user (e.g., “This photo relates to this piece of music”), or the relations may be created automatically. Automatic creation may occur responsive to another action, such as sending a message, or automatic creation may be a result of a process launched to search for associations between media items.

The components of a system for visualizing, accessing, and interacting with metadata-based relations between media objects include a visualization component, an access component, and an interaction component. The visualization component provides a means to inform the user that a certain media item has some relations attached to it. Different relations may be visualized in different ways. Further, the visualization component displays the state of the relation, such as whether it is new or already checked. The access component provides a means to easily access media objects that are related to the object that is currently focused. The interaction component allows the user to manipulate the relations, such as removing them, creating them manually, and verifying them.

Aspects of the visualization component include the novelty of the information, i.e., has the user viewed an automatically created relation or not, and the freshness of the information, i.e., how long ago was the relation discovered. Furthermore, the visualization component must differentiate between automatically and manually created relations, as well as with different types of relations. Optional parts of the visualization component may include, e.g., the importance of the information, i.e., how important the objects in the relation are.

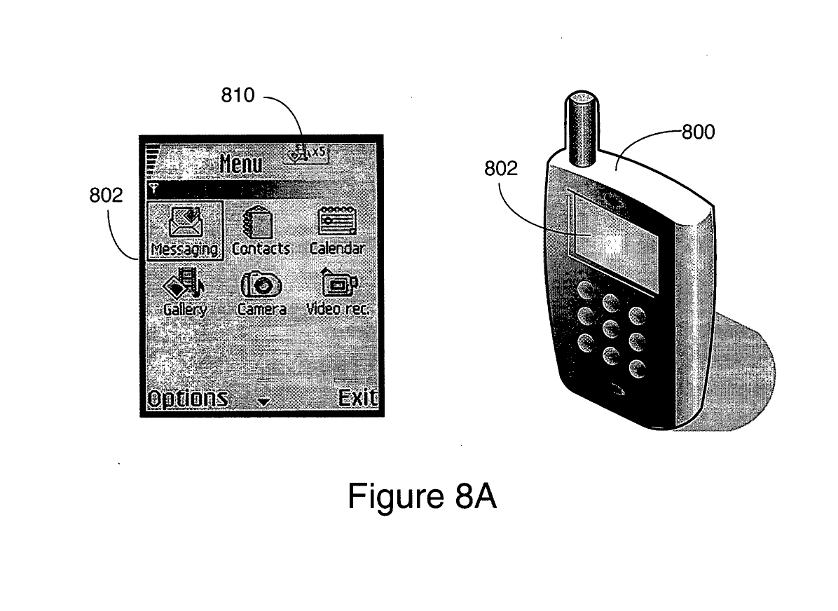

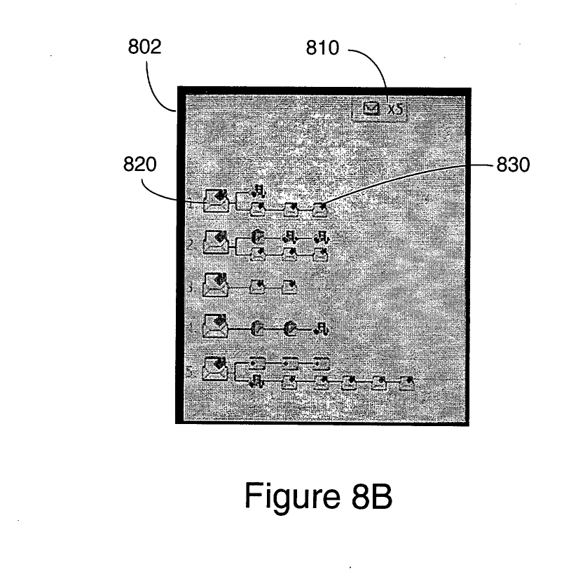

The visualization component works in two levels: a system level and an object level. The system level visualization component is merely an indicator displaying that new relations have been discovered. It may be interactive, providing the user with a shortcut to the discovered new relation. FIG. 8A illustrates an example indicator 810 on a display 802 of a terminal device 800 in accordance with at least one aspect of the present invention as described below. The object level visualization component displays all relation information for each object individually. It provides access to all the other objects that are part of the relation. It also includes advanced views to the relations that display, e.g., graphs. In an object level visualization component, the user is able to select a relation and manipulate it, e.g., remove a relation, or verifying it (i.e., indicating that the discovered relation is rational). An extended system level visualization component can be used when a terminal device is in an idle state. The relation information can be displayed as a screen saver, thus containing much more information compared to a mere indicator.

The visualization component may be interactive. In addition to acting as information providers, visualization components may act as navigation guidelines to the displayed information. The implementation requires that the relations are stored so that they can be retrieved later. As such, a user interface is needed to provide access to the relations. A system-level relation indicator may be displayed as an unobtrusive icon 810 on the screen 802, not unlike the battery and field strength indicators in many terminal devices 800. FIGS. 8A and 8B illustrate examples of such indicators 810. The icon 810 may show that there are new relations discovered and that they relate to messages. The icon 810 also displays the amount and/or type of new relations discovered. The icon's visual appearance may change according to the media types that are included in the relation. If there are several different media types involved, the icon 810 may provide a combination of them. Further, the icon 810 may be partially transparent. The icon's appearance may become more transparent when time passes without the user checking the relation. Once the user has checked for the new discovered relations, the system-level indicator may be removed from the screen until new relations are discovered.

The user may navigate to the system level icon 810 and click on the icon 810 to open a view that displays the discovered relations in detail in the object level view as shown in FIG. 8B. The information may be displayed for each media item separately. The user can see the relations 830 related to any objects 820, as well as the number of them. Further, she can see the media types. The user is able to browse the relations 830, to expand the view, and to select another media item as the root object. As shown in FIG. 8B, the user is able to select and manipulate either complete relation chains or single media items. As an example, the user may choose an item 830 to open, she may select a complete relation chain to remove or verify it, or she may select one or more objects and add or remove them from a relation chain.

Aspects of the present invention describe a system for collecting, associating, and storing context information as metadata. In one embodiment, when an event is detected and created in a superlog, the event is associated with the content data, such as a message that was received, a photo that was saved, and/or a voice recording that was captured. Similarly, the system also collects context data and creates a relation between the context data, the content data, and the event that occurred. Then, the context data, along with the relation, may be stored in a database.

Later, when any part of the relation, whether the context data, the event, or the content data, is accessed and/or searched for, each of the three can complement each other and assist in finding the desired information. The collected context data also may be used for creating associations between content objects that have common values.

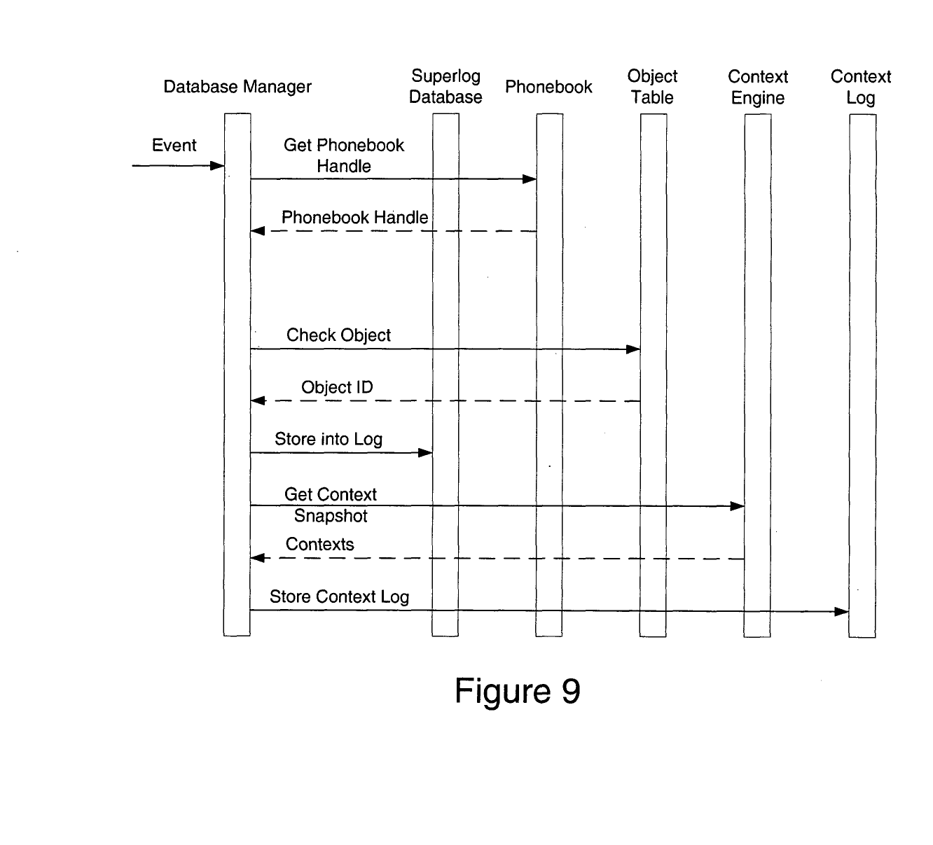

FIG. 9 illustrates a sequence diagram for communications within a system for managing data in accordance with at least one aspect of the present invention. The system uses a context engine for tracking context and a database, such as a superlog, to handle media content events. The solid arrows indicate actions taken by or from the database manager and the dashed arrows indicate actions taken by or from the other components of the system. If a certain, predefined, event occurs, such as the creation of a file, the editing of an image, or the reception of a message, the system requests context data, such as a cell-id, a location, user device's presence information or settings, devices in proximity, persons in proximity, a calendar event, currently open files, and a current application, as metadata from the context engine. The context engine returns the contexts to the database manager. Initially, the database manager may look to a phonebook to obtain personal information related to the event and then content data may be requested from an object table by the database manager. The object data returns the identification of the content to the database manager. The context data then is stored in the database as metadata for use for all metadata-enabled applications.

Since context data in the context engine may be in a different format than the metadata stored in a metadata engine, the system may reformat the context data into a format used in the metadata system. In accordance with one embodiment, the system may be configured so that no reformatting is necessary. The context-enabled database enables versatile formation of different relations between objects, applications, people, and time, thus providing several different ways of accessing the content data.

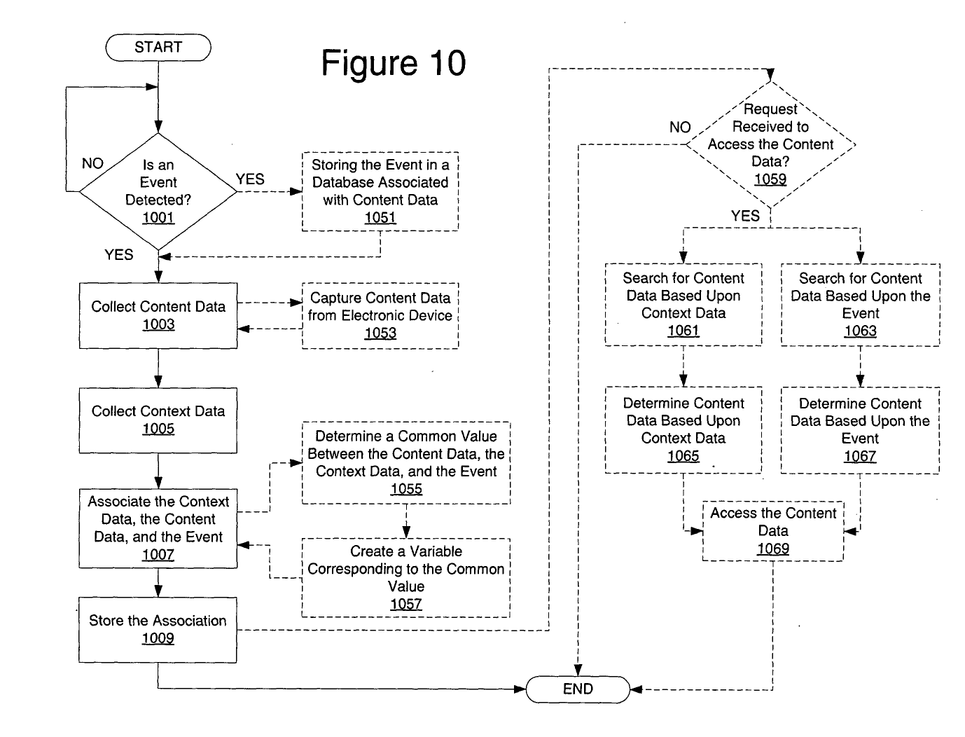

FIG. 10 illustrates a flowchart for associating and accessing data in accordance with at least one aspect of the present invention. The process starts and at step 1001, a determination is made as to whether an event has been detected. If not, the process begins again. If an event is detected, at step 1003, content data corresponding to the event is collected. For example, the actual image data captured by a camera may be included within the content data. Alternatively, and shown in a dotted line form, the process may proceed to step 1051 where the event is stored in a database associated with the content data. At that point, the process proceeds to step 1003. At step 1003, the process has the option of proceeding to step 1053 where the content data is captured from an electronic device.

At step 1005, context data is collected by the system. The process then proceeds to step 1007 where the context data, the content data, and the event are associated with each other. In one embodiment, the process may proceed to step 1055 where a common value is determined between the content data, the context data, and the event. Examples of a common value may include, but are not limited to, an identification number/key which may be used to identify a row in a database table or some type of time stamp associated with the storage of information relating to each. The context, events, and content may be linked together by using a relation/common value. One way is to provide a unique ID for each entity and then make reference to other entities using the ID. In such a case, each of the context, event, and content are provided an ID, and each of them may be referenced to any of the others using the ID. Proceeding to step 1057, a variable is created that corresponds to the determined common value, and the process proceeds back to step 1007.

At step 1009, the association of the content data, the context data, and the event is stored in a database where the process may end. In the alternative, the process may proceed to step 1059 where a determination is made as to whether a request has been received to access the content data. If there has been no request, the process ends. If a request has been received in step 1059, the process may proceed to either or both of steps 1061 and 1063. In step 1061, the content data is searched for based upon the context data. The process proceeds to step 1065 where the content data is determined based upon the context data. Alternatively or concurrently, at step 1063, the content data is searched for based upon the event. The process proceeds to step 1067 where the content data is determined based upon the event. For both of steps 1065 and 1067, the process proceeds to step 1069 where the content data is accessed and the process ends.

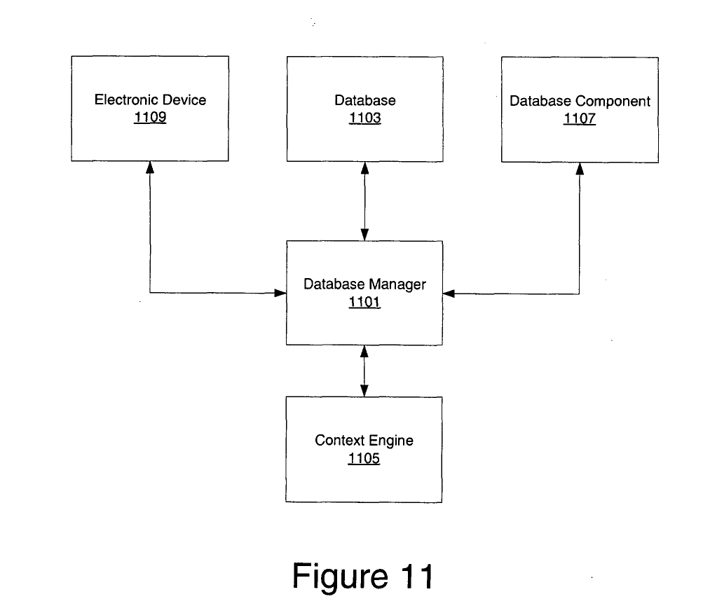

FIG. 11 illustrates a block diagram of an example system for managing data in accordance with at least one aspect of the present invention. The exemplary processes illustrated in the flowchart of FIG. 10 may be implemented by the components of FIG. 11. As shown, the system includes a database manager 1101. Database manager 1101 may be configured to detect the occurrence of an event. Database manager 1101 may be coupled to one or more other components. As used herein, components may be coupled directly or indirectly. Further, the components may be coupled via a wired and/or wireless connection and/or one or more components may be included within another component.

A database 1103 may be coupled to the database manager 1101. Database 1103 may be configured to store content data associated with the event. Database manager 1101 also is shown coupled to a context engine 1105. Context engine 1105 may be configured automatically to collect context data. A database component 1107 is shown coupled to the database manager 1101. Database component 1107 may be configured to store an association between the event, the content data, and the context data. Finally, an electronic device 1109 is shown coupled to the database manager 1101. Electronic device 1109 may be configured to initiate the event that is detected by the database manager 1101.

Other aspects of the present invention include a mechanism that associates a multi-media call session and the result of user actions with other programs, which usage is not directly related to the multi-media call session. This association may be achieved by expanding the multi-media call session logging mechanism. Information that may be logged during a multi-media call session may include the session type, such as a chat, instant messenger, or voice over Internet protocol, participants of the session, and the contact information of the participants. This logged information is related directly to the multi-media call session activities.

In one example, a user may participate in a multi-media call session. During the session, she may open an application allowing her to take notes, write a note, and then save it. The user then may end the session. Some time later, she may want to see what happened during the multi-media call session. When she opens the multi-media call session log, she sees the participants and now also sees the notes related to the multi-media session without knowing the file name or place where the notes were saved.

In another example, a user participates in a multi-media call session with a customer. During the session, she opens a recording application, which records the speech of a portion of the session and saves it. The user then ends the session. Prior to the next customer meeting, she wants to hear what was said during the last session. When she opens the multi-media call session log, she now also sees the speech record related to the multi-media call session without knowing the file name or place where the speech clip was saved.

The management system follows what actions were performed during the multi-media call session. When an application, such as a note application, is launched or stopped, a database makes a record of it. If the launched application saves a file into a file system or computer-readable medium, the information of the filename and location may be saved in the database. These records hold the session identification and the time when the event happened.

A user interface shows the records of the multi-media call sessions for review by a user. The user interface may be configured to allow a user to browse through the records, select the file created during the multi-media call session, and launch the particular application that created the file directly from the user interface. Table 2 illustrates an example of the records that may be stored.

TABLE 2
Example Records

| | |
|---|---|
| SESSION ID: | an identifier of the Rich Call session |
| TIIMESTAMP: | the time of the event |
| ACTOR: | an identifier of the application that created the event |
| ACTION: | an enumerated code for the action (e.g., 1 = saved, |
| | 2 = opened, 3 = launched, 4 = stopped, etc.) |
| OBJECT: | an identifier (ID, filename) to the relevant content object |
| LOCAITON: | an object location (which may be stored elsewhere in the |
| | database or file system) |
| PEOPLE: | a list of people associated with the Rich Call session |

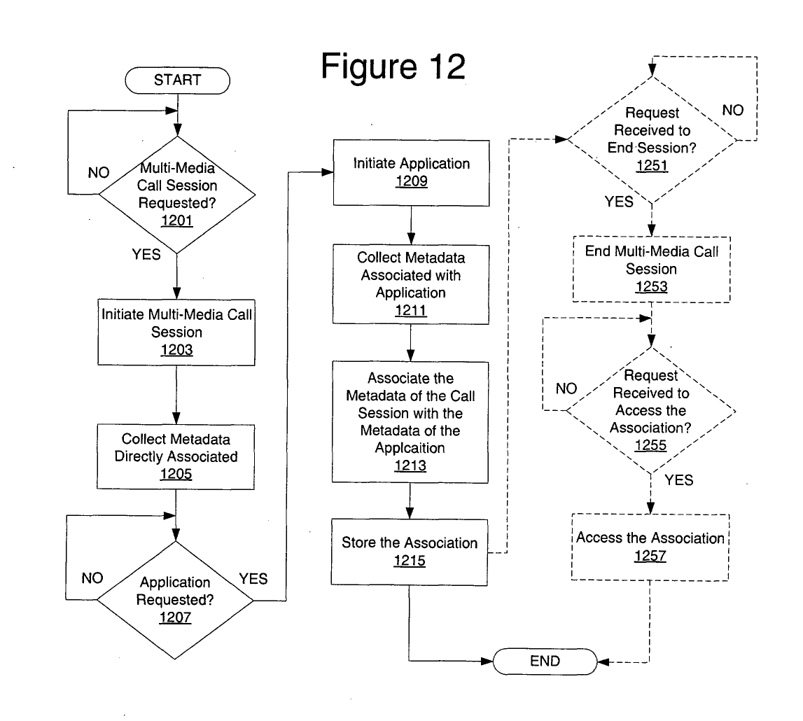

FIG. 12 illustrates another flowchart for associating and accessing data in accordance with at least one aspect of the present invention. The process starts and at step 1201, a determination is made as to whether a multi-media call session has been requested. If not, the process begins again. If a call session has been requested, at step 1203, a multi-media call session is initiated. The multi-media call session may be a Rich Call session. At step 1205, metadata directly associated with the multi-media call session is collected. The process proceeds to step 1207.

At step 1207, a determination is made as to whether an application has been requested. If not, the process repeats step 1207. If an application has been requested, the process moves to step 1209 where the application is initiated. At step 1211, metadata associated with the application is collected. At step 1213, the metadata directly associated with the call session is associated with the metadata associated with the application. At step 1215, the association of the metadata directly associated with the call session and the metadata associated with the application are stored in a database where the process may end. In the alternative, and as shown by the dotted line form, the process may proceed with step 1251 where a determination is made as to whether a request has been received to end the multi-media call session. If not, the process repeats step 1251. If a request has been received, at step 1253, the multi-media call session is ended. At step 1255, a determination is made as to whether a request has been received to access the association stored in the database. If not, the process repeats step 1255. If a request is received, the process moves to step 1257 where the association is accessed and the process ends.

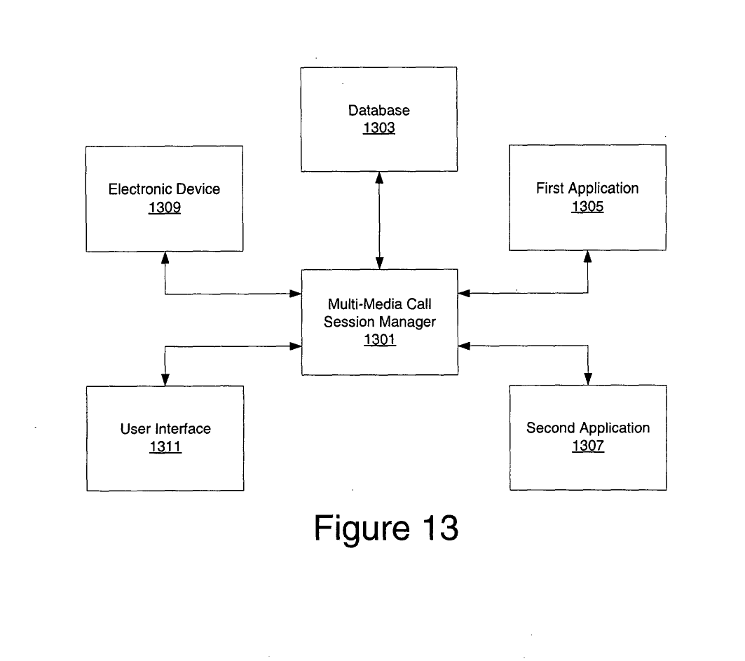

FIG. 13 illustrates another block diagram of an example system for managing data in accordance with at least one aspect of the present invention. The exemplary processes illustrated in the flowchart of FIG. 12 may be implemented by the components of FIG. 13. As shown, the system includes a multi-media call session manager 1301. Manager 1301 may be configured to obtain metadata directly associated with a multi-media call session, to obtain metadata associated with a first application 1305 and/or second application 1307, and to create an association between the metadata directly associated with the multi-media call session and the metadata associated with the first application 1305 and/or second application 1307. Manager 1301 may be coupled to one or more other components. As used herein, components may be coupled directly or indirectly. Further, the components may be coupled via a wired and/or wireless connection and/or one or more components may be included within another component.

A database 1303 may also be coupled to the multi-media call session manager 1301. Database 1303 may be configured to store the association between the metadata directly associated with the multi-media call session and the metadata associated with the first application 1305 and/or second application 1307. An electronic device 1309 also may be configured to interface with the multi-media call session manager 1301 to make requests for access to metadata and associations between metadata. Finally, a user interface 1311 may be coupled to the multi-media call session manager 1301. User interface 1311 may be configured to provide the metadata directly associated with the multi-media call session and the metadata associated with the application.

One or more aspects of the invention may be embodied in computer-executable instructions, such as in one or more program modules, executed by one or more computers, set top boxes, mobile terminals, or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

Although the invention has been defined using the appended claims, these claims are exemplary in that the invention may be intended to include the elements and steps described herein in any combination or sub combination. Accordingly, there are any number of alternative combinations for defining the invention, which incorporate one or more elements from the specification, including the description, claims, and drawings, in various combinations or sub combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention. It may be intended that the written description of the invention contained herein covers all such modifications and alterations.

We claim:

1. A method for managing metadata, the method comprising steps of:
receiving a request from an application to access a metadata attribute corresponding to a piece of content;
determining whether the application is authorized to access the metadata attribute;
retrieving the metadata attribute upon determining that the application is authorized to access the metadata attribute; and
transmitting the metadata attribute to the application,
wherein the metadata attribute is stored in a metadata storage medium separate from the piece of content.

2. The method of claim 1, wherein the step of retrieving includes steps of:
accessing a metadata storage medium;
searching the metadata storage medium for the metadata attribute; and
identifying the metadata attribute.

3. The method of claim 2, wherein the step of retrieving includes a step of decrypting the metadata attribute.

4. The method of claim 1, further comprising steps of:
determining whether the metadata attribute has been modified; and
automatically storing the modified metadata attribute.

5. The method of claim 4, wherein upon determining the metadata attribute has been modified, the method includes a step of modifying a second metadata attribute to indicate the modified first metadata attribute.

6. The method of claim 4, wherein the step of automatically storing includes automatically storing the modified metadata attribute in a device external to the application.

7. The method of claim 1, wherein the request from the application to access the metadata attribute is a request to modify the metadata attribute.

8. The method of claim 7, further comprising a step of modifying the metadata attribute in response to the request from the application.

9. The method of claim 1, wherein the step of determining includes determining an access right to modify the metadata attribute.

10. The method of claim 9, wherein the access right is an indication of applications authorized to modify the metadata attribute.

11. The method of claim 1, wherein the metadata attribute is a private metadata attribute.

12. A computer-readable medium storing computer-executable instructions for performing the steps recited in claim 1.

13. A system for managing metadata, comprising:
an authorization system configured to determine whether an application is authorized to access a metadata attribute corresponding to a content object;
a metadata engine configured to receive requests to access the metadata attribute from the authorization system and to transmit the metadata attribute to the authorization system;
a metadata storage system configured to store the metadata attribute corresponding to content objects; and
a media database configured to store content objects, the media database being external to and separate from the metadata storage system.

14. The system of claim 13, further comprising a harvester configured to analyze the content object to obtain the metadata attribute.

15. The system of claim 13, further comprising a filter configured to extract the metadata attribute from the content object.

16. The system of claim 13, further comprising a search tool configured to search the metadata storage system for the metadata attribute.

17. The system of claim 13, wherein the authorization system, the metadata engine, the metadata storage system, and the media database are software components.

18. The system of claim 13, wherein the system is a terminal device.

19. The system of claim 13, wherein the system is a server.

20. The system of claim 13, further comprising a terminal device including an application configured to request access to metadata attributes corresponding to content objects.

21. The system of claim 20, wherein the terminal device includes the authorization system.

22. The system of claim 13, wherein the metadata storage subsystem and the media storage subsystem are stored separately in a common storage subsystem.

23. A user interface in a computer for reviewing a relationship of objects, comprising:
a first portion configured to indicate the existence of at least one new relationship between a content object and another object; and
a second portion configured to indicate a type of the at least one new relationship.

24. The user interface of claim 23, further comprising a third portion configured to indicate the number of the at least one new relationship.

25. The user interface of claim 23, further comprising a third portion configured to change in appearance and to indicate a whether the at least one new relationship has been accessed.

26. The user interface of claim 23, wherein the first portion is further configured to receive a user input to open the at least one new relationship.

27. The user interface of claim 23, wherein the type of at least one new relationship is at least one of: a media file and a text file.

28. A method for associating data, the method comprising steps of:
detecting the occurrence of an event;
collecting content data;
automatically collecting context data;
associating the context data, the content data, and the event; and
storing the association of the content data, the context data, and the event,
wherein the step of associating includes a step of creating a variable corresponding to a common value between the content data, the context data, and the event.

29. The method of claim 28, wherein the step of detecting includes a step of storing the event in a superlog.

30. The method of claim 28, wherein the step of collecting content data includes a step of capturing the content data with an electronic device.

31. The method of claim 28, wherein the context data is predefined contextual metadata.

32. The method of claim 28, wherein the method of storing includes a step of storing the association of the content data, context data, and the event as metadata.

33. The method of claim 28, further comprising a step of accessing the content data, wherein the step of accessing the content data includes a step of determining the content data based upon the context data.

34. The method of claim 28, further comprising a step of accessing the content data, wherein the step of accessing the content data includes a step of determining the content data based upon the event.

35. The method of claim 28, further comprising a step of accessing the content data, wherein the step of accessing the content data includes a step of searching for the content data.

36. The method of claim 35, wherein the step of searching for the content data includes a step of searching for the content data based upon at least one of the context data and the event.

37. A computer-readable medium storing computer-executable instructions for performing the steps recited in claim 28.

38. A system for managing data, comprising:
a database manager configured to detect the occurrence of an event;
a database configured to store content data associated with the event;
a context engine configured automatically to collect context data;
a database component configured to store an association between the event, the content data, and the context data, the database manager being configured to create a variable corresponding to a common value between the content data, the context data, and the event.

39. The system of claim 38, further comprising an electronic device configured to initiate the event.

40. The system of claim 38, wherein the database manager is configured to request context data from the context engine to associate with the event.

41. The system of claim 38, wherein the database manager is configured to request content data from the database to associate with the event.

42. The system of claim 38, wherein the stored association includes metadata.

43. The system of claim 38, wherein the database manager is configured to receive a request to access the content data.

44. The system of claim 43, wherein the database manager is configured to request the content data based upon the event.

45. The system of claim 43, wherein the database manager is configured to request the content data based upon the context data.

46. The system of claim 43, wherein the request to access the content data is a request to search for the content data.

47. The system of claim 46, wherein the request to search for the content data is based upon at least one of the context data and the event.

48. A method of associating data, the method comprising steps of:
initiating a multi-media call session;
obtaining metadata directly associated with the multi-media call session;
initiating an application independent of the multi-media call session;
obtaining metadata associated with the application; and
automatically associating the metadata directly associated with the multi-media call session and the metadata associated with the application.

49. The method of claim 48, wherein the multi-media call session is a Rich Call session.

50. The method of claim 48, wherein the metadata associated with the application includes a filename of a file saved by the application.

51. The method of claim 48, further comprising a step of storing the association of the metadata directly associated with the multi-media call session and the metadata associated with the application.

52. The method of claim 51, wherein the step of storing includes storing in a database directly associated with the multi-media call session.

53. The method of claim 52, further comprising steps of:
accessing the database; and
providing the metadata associated with the application and the metadata directly associated with the multi-media call session.

54. The method of claim 52, further comprising a step of ending the multi-media call session, wherein the step of ending occurs prior to the step of accessing.

55. The method of claim 48, further comprising steps of:
initiating a second application independent of the multi-media call session;
obtaining metadata associated with the second application; and
automatically associating the metadata directly associated with the multi-media call session and the metadata associated with the second application.

56. The method of claim 55, further comprising steps of:
receiving a request to initiate the application from a first source; and
receiving a request to initiate the second application from a second source.

57. A computer-readable medium storing computer-executable instructions for performing the steps recited in claim 48.

58. A system for managing data, comprising:
a multi-media call session manager configured to obtain metadata directly associated with the multi-media call session, to obtain metadata associated with an application, and to create an association between the metadata directly associated with the multi-media call session and the metadata associated with the application; and
a database component configured to store the association.

59. The system of claim 58, wherein the multi-media call session is a Rich Call session.

60. The system of claim 58, wherein the metadata associated with the application includes a filename of a file saved by the application.

61. The system of claim 58, further comprising a database directly associated with the multi-media call session, wherein the database includes the database component.

62. The system of claim 58, wherein the multi-media call session manager further is configured to receive requests to access the database.

63. The system of claim 62, wherein the multi-media call session manager further is configured to provide the metadata associated with the application and the metadata directly associated with the multi-media call session.

64. The system of claim 58, wherein the multi-media call session manager further is configured to obtain metadata associated with a second application and to create an association between the metadata directly associated with the multi-media call session and the metadata associated with the second application.

65. The system of claim 64, wherein the multi-media call session manager further is configured to receive a request to initiate the application from a first source and to receive a request to initiate the second application from a second source.

66. The system of claim 58, further comprising a user interface, coupled to the multi-media call session manager, configured to provide the metadata directly associated with the multi-media call session and the metadata associated with the application.

67. The system of claim 58, further comprising a user interface, coupled to the multi-media call session manager, configured to provide the association between the metadata directly associated with the multi-media call session and the metadata associated with the application.

68. A method of associating data, the method comprising steps of:
receiving a request to initiate a multi-media call session;
initiating the multi-media call session;
collecting metadata directly associated with the multi-media call session;
receiving a request to initiate an application;
initiating the application, wherein the application is independent of the multi-media call session and allows for notations to be saved;
collecting metadata associated with the application;
automatically associating the metadata directly associated with the multi-media call session and the metadata associated with the application;
storing the association;
receiving a request to end the multi-media call session;
ending the multi-media call session;
receiving a request to access the association; and
providing the metadata associated with the application and the metadata directly associated with the multi-media call session.
